(19) United States
(12) Patent Application Publication
(10) Pub. No.: US 2022/0183491 A1
(43) Pub. Date: Jun. 16, 2022

(54) Parcel Security Assembly

(71) Applicant: Mitchell Cooper, Laguna Niguel, CA (US)

(72) Inventor: Mitchell Cooper, Laguna Niguel, CA (US)

(21) Appl. No.: 17/123,860

(22) Filed: Dec. 16, 2020

(51) Int. Cl. A47G 29/20; E05B 37/00

(52) U.S. Cl. CPC A47G 29/20; E05B 37/0068

(57) ABSTRACT

A parcel security assembly for securing a parcel for an intended recipient includes a bag that is comprised of a resilient material to securely store a parcel. A pair of closures is each integrated into the bag for opening and closing the bag. A lock is removably attachable to each of the closures when each of the closures is positioned in a closed position. In this way the lock inhibits the parcel from being removed from the bag. A strap is coupled to the bag and the strap is slidable beneath a door. The strap has a loop thereon and the loop is positionable around an interior door knob of the door to inhibit the bag from being stolen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to security devices and more particularly pertains to a new security device for securing a parcel for an intended recipient. The security device includes a strap that is looped over an interior knob on a door and a bag that is coupled to the strap. The parcel is locked in the bag when the parcel is delivered until the intended recipient unlocks the bag.

### (2) Description of Related Art Including Information Disclosed Under 37 CFR 1.97 and 1.98

The prior art relates to security devices including a variety of locking pouches for securing storing an object. The prior art discloses a parcel security pouch which includes a strap that is extended beneath a door and an anchor on the strap that inhibits the strap from being slid beneath the door. The prior art further discloses a variety of parcel storage devices that are attached to a door.

### BRIEF SUMMARY OF THE INVENTION

An embodiment of the disclosure meets the needs presented above by generally comprising a bag that is comprised of a resilient material to securely store a parcel. A pair of closures is each integrated into the bag for opening and closing the bag. A lock is removably attachable to each of the closures when each of the closures is positioned in a closed position. In this way the lock inhibits the parcel from being removed from the bag. A strap is coupled to the bag and the strap is slidable beneath a door. The strap has a loop thereon and the loop is positionable around an interior door knob of the door to inhibit the bag from being stolen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a parcel security assembly according to an embodiment of the disclosure.

FIG. 2 is a top view of an embodiment of the disclosure.

FIG. 3 is a phantom perspective in-use view of an embodiment of the disclosure.

FIG. 4 is a right side cut-away view of an embodiment of the disclosure.

FIG. 5 is a perspective in-use view of an embodiment of the disclosure.

FIG. 6 is a perspective view of an alternative embodiment of the disclosure.

### DETAILED DESCRIPTION OF THE INVENTION

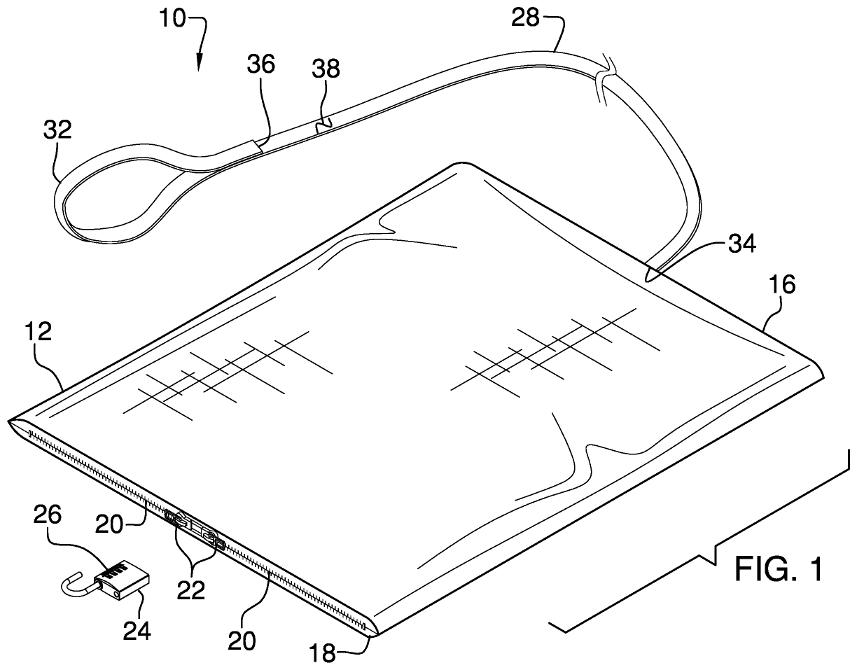

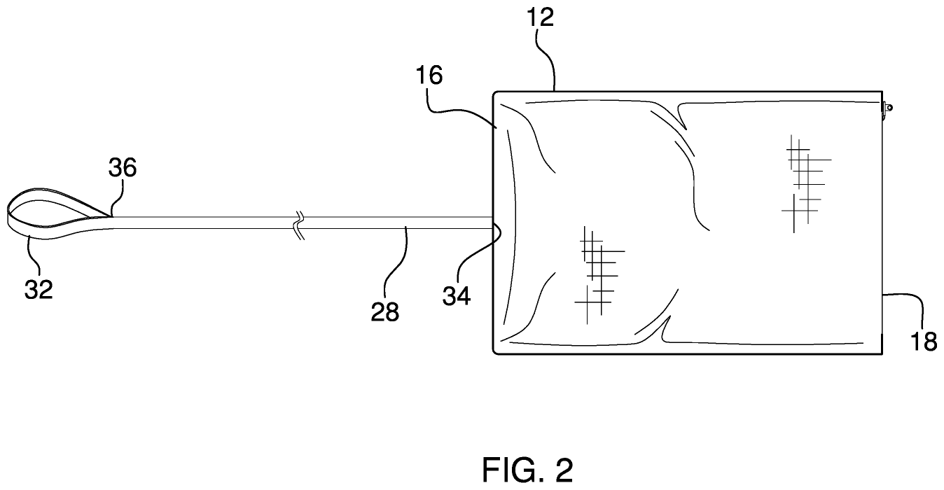

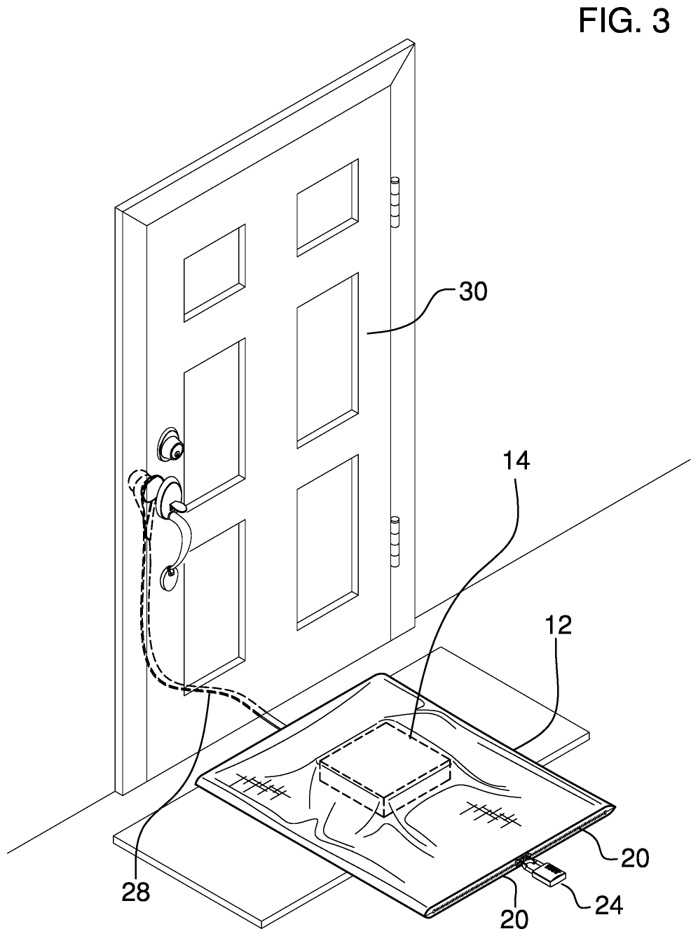

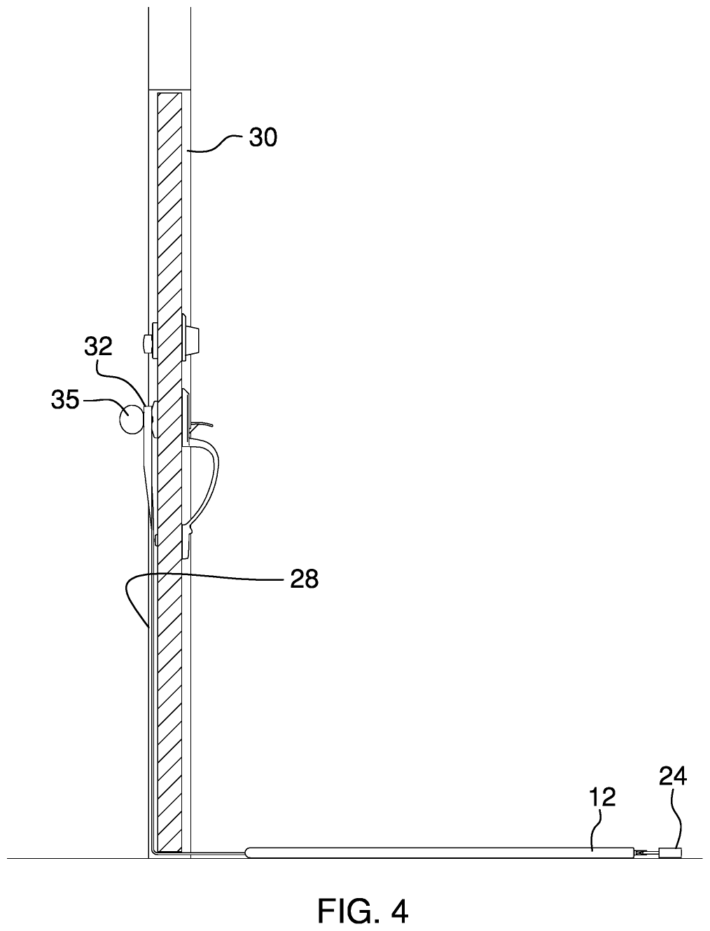

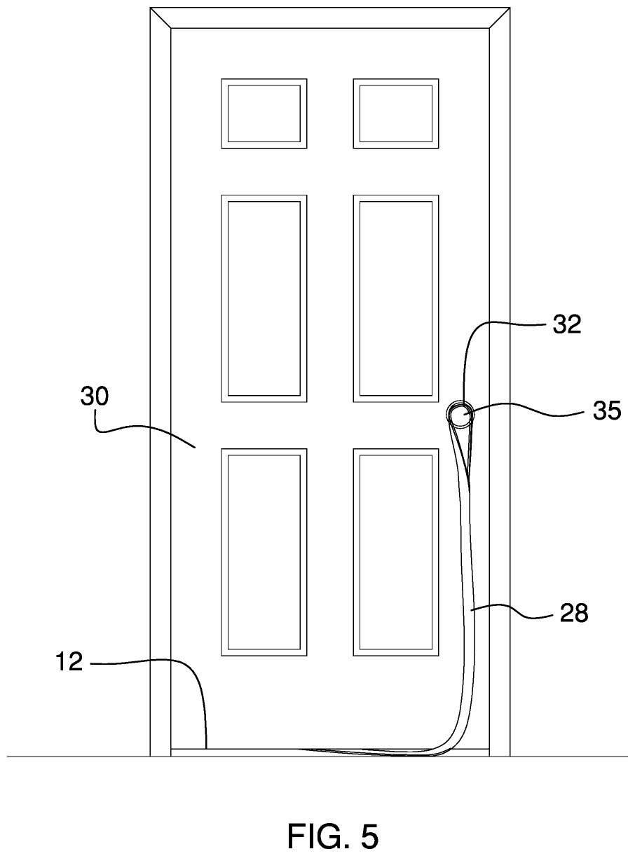

With reference now to the drawings, and in particular to FIGS. 1 through 6 thereof, a new security device embodying the principles and concepts of an embodiment of the disclosure and generally designated by the reference numeral 10 will be described.

As best illustrated in FIGS. 1 through 6, the parcel security assembly 10 generally comprises a bag 12 that is comprised of a resilient material to securely store a parcel 14. The resilient material may be a Teflon fabric or other similar material that is puncture resistant and tear resistant. The bag 12 has a front end 16 and a back end 18, and the back end 18 is open to access an interior of the bag 12 and to facilitate the parcel 14 to be inserted into the bag 12. A pair of closures 20 is provided and each of the closures 20 is integrated into the bag 12. Each of the closures 20 opens and closes the bag 12, and each of the closures 20 is positioned on the back end 18 of the bag 12.

Each of the closures 20 partially closes the back end 18 such that an entirety of the back end 18 is closed when each of the closures 20 is closed. Each of the closures 20 has an engagement 22 that is slidable along the back end 18. Moreover, the engagement 22 associated with each of the closures 20 is positioned adjacent to each other when each of the closures 20 is closed. Each of the closures 20 may comprise a zipper and the engagement 22 may comprise a slide and a pull of the zipper. Additionally, each of the closures 20 may comprise a mechanical closure of any conventional design.

A lock 24 is provided and the lock 24 is removably attachable to each of the closures 20 when each of the closures 20 is positioned in the closed position. In this way the lock 24 inhibits the parcel 14 from being removed from the bag 12 and potentially stolen. The lock 24 may have a combination tumbler 26 that is integrated therein. The lock 24 may be unlocked when the combination tumbler 26 is manipulated into a predetermined combination to inhibit the closures 20 from being opened by anyone other than an intended recipient of the parcel 14. The lock 24 may be a combination lock, a keyed lock or any other type of lock that can be only be opened by the intended recipient of the parcel 14.

A strap 28 is provided and the strap 28 is coupled to the bag 12. The strap 28 is slidable beneath a door 30, which may be an exterior door in an entry of a residence or the like. The strap 28 has a loop 32 thereon and the loop 32 is positionable around an interior door knob 35 of the door 30. In this way the strap 28 inhibits the bag 12 from being stolen. The strap 28 has a first end 34 and a second end 36, and the first end 34 is coupled to the front end 16 of the bag 12. The strap 28 is looped onto itself such and the second end 36 is coupled to an outer surface 38 of the strap 28 to form the loop 32.

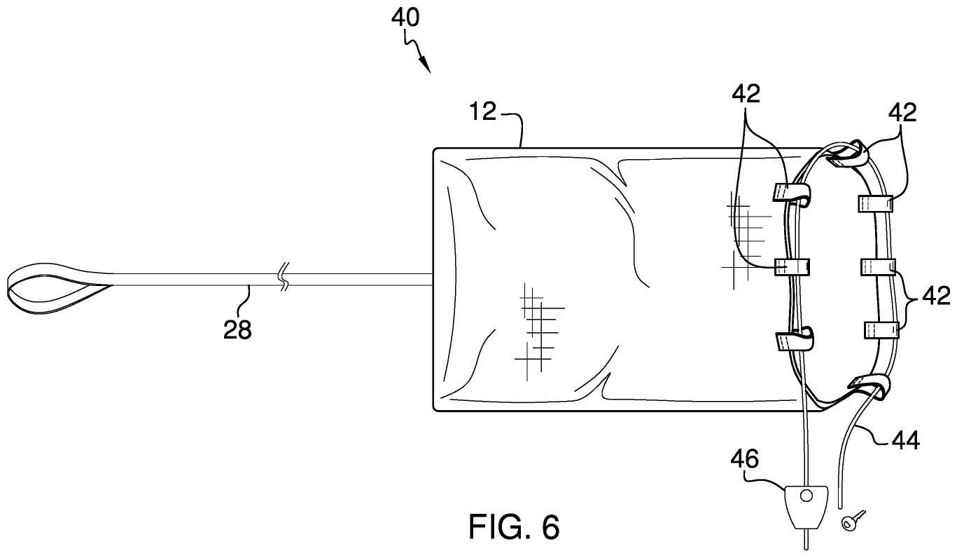

In an alternative embodiment 40 as is most clearly shown in FIG. 6, a plurality of loops 42 may be coupled to the bag 12. The loops 42 might be spaced apart from each other and be distributed around the back end 18 of the bag 12. A cable 44 might be extendable through each of the loops 42 to facilitate the back end 18 of the bag 12 to be drawn closed with the cable 44. A locking mechanism 46 may engage the cable 44 when the bag 12 is drawn closed for securing the parcel 14 in the bag 12.

In use, the bag 12 is placed outside, the strap 28 is extended beneath the door 30 and the loop 32 is positioned around the interior door knob 35. The parcel 14 is inserted into the bag 12 when the parcel 14 is delivered and each of the closures 20 is moved into the closed position. The lock 24 is locked between each of the closures 20 for securing the parcel 14 in the bag 12. In this way the parcel 14 is secured until the intended recipient can unlock the lock 24 and remove the parcel 14 from the bag 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A parcel security system comprising:
a door having an interior door knob;
a bag being comprised of a resilient material wherein said bag is configured to securely store a parcel;
a pair of closures, each of said closures being integrated into said bag, said each of said closures opening and closing said bag;
a lock being removably attachable to each of said closures when each of said closures is positioned in a closed position wherein said lock is configured to inhibit the parcel from being removed from said bag; and
a strap being coupled to said bag, said strap having a length sufficient o extend from said bag on an exterior side of said door, under said door, and to said interior door knob, said strap having a loop thereon, said loop being positionable around said interior door knob of the door wherein said strap inhibits said bag from being stolen.

2. The system according to claim 1, wherein:
said bag has a front end and a back end, said back end being open to access an interior of said bag wherein said back end is configured to facilitate the parcel to be inserted into said bag; and
each of said closures is positioned on said back end of said bag, each of said closures partially closing said back end such that an entirety of said back end is closed when each of said closures is closed.

3. The system according to claim 2, wherein each of said closures has an engagement being slidable along said back end, said engagement associated with each of said closures being positioned adjacent to each other when each of said closures is closed.

4. The system according to claim 2, wherein said strap has a first end and a second end, said first end being coupled to said front end of said bag, said strap being looped onto itself such that said second end is coupled to said an outer surface of said strap to form said loop.

5. The system according to claim 1, wherein:
said bag has a front end and a back end, said back end being open to access an interior of said bag wherein said back end is configured to facilitate the parcel to be inserted into said bag;
each of said closures is positioned on said back end of said bag, each of said closures partially closing said back end such that an entirety of said back end is closed when each of said closures is closed, each of said closures having an engagement being slidable along said back end, said engagement associated with each of said closures being positioned adjacent to each other when each of said closures is closed;
said lock has a combination tumbler being integrated therein, said lock being unlocked when said combination tumbler is manipulated into a predetermined combination wherein said lock is configured to inhibit said closures from being opened by anyone other than an intended recipient of the parcel; and
said strap has a first end and a second end, said first end being coupled to said front end of said bag, said strap being looped onto itself such that said second end is coupled to said an outer surface of said strap to form said loop.

6. A parcel security system for securing a parcel until an authorized recipient retrieves the parcel, said assembly comprising:
a door being hingedly integrated into an entry of a building, said door having an interior knob;
a bag being comprised of a resilient material wherein said bag is configured to securely store a parcel, said bag having a front end and a back end, said back end being open to access an interior of said bag wherein said back end is configured to facilitate the parcel to be inserted into said bag;
a pair of closures, each of said closures being integrated into said bag, said each of said closures opening and closing said bag, each of said closures being positioned on said back end of said bag, each of said closures partially closing said back end such that an entirety of said back end is closed when each of said closures is closed, each of said closures having an engagement being slidable along said back end, said engagement associated with each of said closures being positioned adjacent to each other when each of said closures is closed;
a lock being removably attachable to each of said closures when each of said closures is positioned in said closed position wherein said lock is configured to inhibit the parcel from being removed from said bag, said lock having a combination tumbler being integrated therein, said lock being unlocked when said combination tumbler is manipulated into a predetermined combination wherein said lock is configured. to inhibit said closures from being opened by anyone other than an intended recipient of the parcel; and
a strap being coupled to said bag, said strap being slidable beneath said door, said strap having a loop thereon, said loop being positionable around said interior door knob of the door wherein said strap is configured to inhibit said bag from being stolen, said strap having a first end and a second end, said first end being coupled to said front end of said bag, said strap being looped onto itself such that said second end is coupled to said an outer surface of said strap to form said loop.

7. A method of securing a parcel for an intended recipient, the steps of the method comprising:
providing a bag having an open end;
providing a pair of closures, each of said closures being integrated into said open end of said bag for opening and closing said open end;
providing a lock being lockable onto each of said closures when said closures are positioned in a closed position;
providing a strap being coupled to said bag, said strap having a loop being integrated therein;
sliding said strap beneath a door having said bag being positioned outside;
placing said loop on said strap around an interior knob of the door thereby securing said bag to the door;
inserting a parcel into said open end of said bag;
manipulating each of said closures into said closed position;
locking said lock onto each of said closures to lock the parcel inside of said bag;
entering a combination. into said lock to remove said lock from said closures;
removing said lock from said closures when said combination is entered into said lock; and
manipulating each of said closures into an open position for retrieving the parcel from said bag.
